(19) United States
(12) Patent Application Publication
(10) Pub. No.: US 2004/0140211 A1
(43) Pub. Date: Jul. 22, 2004

(54) Modular interface and coupling system and method

(76) Inventors: Stephen H. Broy, Riverside, CA (US); Karl F. Penson, Duarte, CA (US)

Correspondence Address: KIRKPATRICK & LOCKHART LLP, 535 SMITHFIELD STREET, PITTSBURGH, PA, 15222, US

(21) Appl. No.: 10/348,103

(22) Filed: Jan. 21, 2003

(51) Int. Cl. G01N 27/26; G01F 1/64

(52) U.S. Cl. 204/424; 205/785.5

(57) ABSTRACT

An interface for coupling a fluid distribution component to a substrate, the interface including an opening therein for receiving at least a portion of the distribution component, the interface including at least one entering pathway and at least one exiting pathway engaging the opening and providing fluid communication between the fluid distribution component and the substrate. The coupling arrangements of the present invention provide a means by which distribution components, such as gas sensors, of various manufacturer designs may be interchangeable.

### BACKGROUND

1. Field of the Invention

This invention relates to a modular interface and a system and method of coupling fluid distribution components, such as gas sensors to substrates.

2. Brief Description of the Invention Background

FIG. 1 illustrates a typical oxygen sensor 110 such as, for example, a Teledyne Analytical Instruments B2 oxygen sensor available from Teledyne Electronic Technologies, City of Industry, California. The oxygen sensor 110 consists of a cathode 102 and an anode 104 sealed in a housing 106 filled with a suitable electrolyte solution. Oxygen diffuses into the interior of the sensor housing 106 through an oxygen permeable sensing membrane 108. A flexible expansion membrane 112 at an opposite end of the sensor 110 permits expansion or contraction of the electrolyte volume. The sensing membrane 108 is sealed in place by means of press fit, and the expansion membrane 112 is sealed in place by means of heat seal. Oxygen is reduced at the cathode 102, which causes current to flow from the cathode 102 to the anode 104, through an externally connected sensing circuit (not shown).

Typically, the oxygen sensor is connected to one of various types of process equipment using a variety of attachment means well known to those of ordinary skill in the art. For example, and as illustrated in FIGS. 2 and 3, the gas sensor 110 may be positioned between a cap portion 125 and a cavity portion 105 of a cell block for installation into an analyzer 130. The cell block exposes the sensor 110 to only a sample gas stream, and provides hermetic electrical connections to the cathode, anode, and other necessary electrical terminals of the sensor. The particular system employed to attach the sensor to other fluid distribution components can be any system the manufacturer determines is appropriate to provide a suitable level of sealing engagement.

There has been an increasing demand on manufactures of fluid distribution systems, such as gas measurement systems and gas sensors, to provide a standardized connection or linkage between components of the systems. In this way, components of different manufacturers will be interchangeable. To address this demand, the Instrumentation, Systems, and Automation Society (ISA) has published proposed guidelines for establishing properties and physical dimensions of a standard interface for surface-mount fluid distribution components for use with process analyzer and sample-handling systems, such as gas sensors and other fluid distribution or fluid measurement systems. As discussed in further detail below, these guidelines are provided in the ISA publication ANSI/ISA-76.00.02-2002, entitled “Modular Component Interfaces for Surface-Mount Fluid Distribution Components-Part 1: Elastomeric Seals” (identified hereinafter as “SP76 Guidelines”) which are incorporated by reference herein in their entirety. The SP76 Guidelines introduce and suggest the adoption of a modular interface between fluid distribution components, such as gas sensors, and a substrate. The SP76 Guidelines also provide footprint dimensions of the modular interface to permit interchangeability of the components in fluid measuring systems. The SP76 Guidelines, however, do not provide or suggest methods of mounting components to the modular interface.

Currently, there is little interchangeability of fluid distribution components, such as gas sensors, in fluid distribution and fluid measuring systems. Though largely impracticable, if it is possible to interchange one gas sensor with another, doing so is typically time-consuming, costly, and inefficient. In addition, the multiple variations of tubing and adaptors that may be needed for component interchangeability may reduce the effectiveness of a component to monitor, measure, or sense an incoming stream. Such reduced effectiveness may occur as a result of, for example, leakage through the seals associated with the adaptors employed.

Further improvements would be a welcome addition to the art, wherein the interchangeability of fluid distribution components, such as gas sensors, is particularly difficult in view of the lack of clear industry standards.

### BRIEF SUMMARY OF THE INVENTION

The present invention addresses the above-mentioned needs by providing a modular interface and a system and method of coupling components thereto.

In one embodiment, the present invention provides an interface for coupling a fluid distribution component, such as, for example, a gas sensor to a substrate. The interface includes an opening therein for receiving at least a portion of the distribution component. The interface also provides at least one entering pathway and at least one exiting pathway for a gas or other fluid engaging the opening and allowing fluid communication between the fluid distribution component and the substrate.

The present invention also provides a system for coupling including a fluid distribution component, a substrate, and an interface. The interface is positioned between and engages the fluid distribution component and the substrate, and includes an opening therein for receiving at least a portion of the fluid distribution component. The interface includes at least one entering pathway and at least one exiting pathway for a gas or other fluid engaging the opening and allowing fluid communication between the fluid distribution component and the substrate.

The present invention is also directed to a method of forming an interface for coupling to a fluid distribution component. The method includes forming an opening in the interface, the opening receiving at least a portion of the fluid distribution component, and wherein at least one entering pathway and at least one exiting pathway for a gas or other fluid extend into the opening and allow fluid communication with the distribution component.

The present invention is also directed to a method of coupling a fluid distribution component to an interface. The method comprises positioning the fluid distribution component over an opening in the interface. The opening is positioned to receive at least a portion of the fluid distribution component, and the interface includes at least one entering pathway and at least one exiting pathway for a gas or other fluid extending into the opening to provide fluid communication with the fluid distribution component. At least a portion of the fluid distribution component is secured within the opening and allows fluid communication between the fluid distribution component and the interface.

### BRIEF DESCRIPTION OF THE SEVERAL VIEWS OF THE DRAWING

The characteristics and advantages of the present invention may be better understood by reference to the accompanying drawings, wherein like reference numerals designate like elements and in which:

FIG. 1 is a cross-sectional view of a prior art gas sensor;

FIG. 2 is a cross-sectional view of the prior art gas sensor of FIG. 1 placed on a conventional cell holder;

FIG. 3 is a cross-sectional view of the prior art gas sensor of FIG. 1 installed into a conventional gas sensor (cell) block analyzer;

FIG. 4 is a top planar view of a modular interface set forth in the SP76 Guidelines;

FIG. 4A is a cross-sectional view of the interface of FIG. 4 taken along line x, and showing one manner of attachment to a substrate;

FIG. 4B is a top planar view of a modified form of an interface set forth in the SP76 Guidelines;

FIG. 4C is a cross-sectional view of the interface of FIG. 4B taken along line y, and showing one manner of attachment to a substrate;

FIG. 5 is a cross-sectional view of one embodiment of the present invention, and illustrating a gas sensor engaging the interface and the substrate;

FIG. 6 is a cross-sectional view of another embodiment of the present invention, and illustrating a gas sensor engaging the interface and the substrate; and

FIG. 7 is a cross-sectional view of another embodiment of the present invention, and illustrating a gas sensor engaging the interface and the substrate.

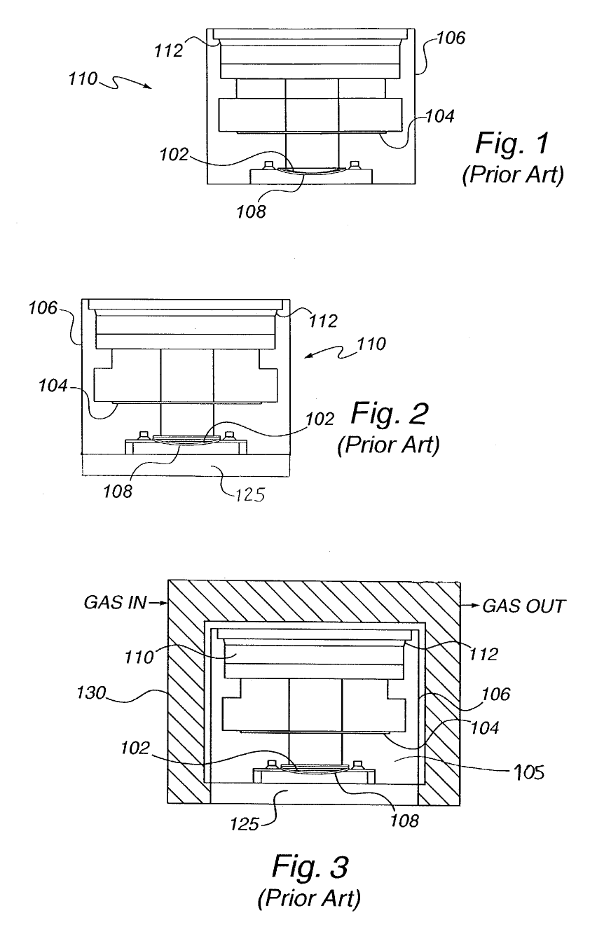

### DETAILED DESCRIPTION OF EMBODIMENTS OF THE INVENTION

In the present detailed description of the invention, the invention will be illustrated in the form of a gas sensor adapted for use as a sealed galvanic oxygen sensor. It will be understood, however, that the invention is not limited to embodiment in such form and may have application in any fluid distribution component. Thus, while the present invention is capable of embodiment in many different forms, for ease of description this detailed description and the accompanying drawings disclose only specific forms as examples of the invention. Those having ordinary skill in the relevant art will be able to adapt the invention to application in other forms not specifically presented herein based upon the present description.

Also, for ease of description, the invention and devices to which it may be attached may be described herein in a normal operating position, and terms such as upper, lower, front, back, horizontal, proximal, distal, etc., may be used with reference to the normal operating position of the referenced device or element. It will be understood, however, that the apparatus of the invention may be manufactured, stored, transported, used, and sold in orientations other than those described.

Other than in the examples herein, or unless otherwise expressly specified, all of the numerical ranges, amounts, values and percentages, such as those for dimensions, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may 1 vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used).

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As used herein, the term “modular interface” or “interface” is defined as an adaptor bracket or linkage that acts as a connector between a fluid distribution component, such as, for example, a gas sensor, and a substrate as set forth herein and as outlined and described in the SP76 Guidelines. The term “substrate”, as used herein, is defined as one or more layers, structures, or fluid distribution components that act as a building block to which other fluid distribution components, such as gas sensors, may be connected via the interface. The term “substrate” may refer to various fluid distribution components, such as gas measuring or monitoring equipment, for example, gas sensors (such as, for example, vacuum sensors, flow sensors, and thermal conductivity sensors), valves, flow meters, flow switches, pressure regulators and reducers, pressure gauges and sensors, analyzers, particulate removal devices, and the like. A substrate may be, but need not be, the first component to which the remaining components are attached. As set forth in detail herein, the present invention provides a modular interface and a system and method of coupling the interface to fluid distribution components, such as a gas sensor.

Typical galvanic oxygen sensors consist, in part, of a machined plastic body filled with electrolyte solution, a cathode (also known as a working electrode) manufactured from perforated sheet metal such as, for example, brass and plated with an appropriate noble metal such as, for example, rhodium, gold, or silver, and an anode (also known as a counter electrode) formed of any anode material such as, for example, compressed lead pellets. The electrolyte solution may be potassium hydroxide. A gaseous stream enters the body by diffusing through a synthetic membrane positioned at an inlet and is transported through a thin electrolyte layer to the working electrode. The oxygen is reduced to form hydroxyl ions at the working electrode. The potential applied on the cathode provides the driving force for the reduction of oxygen. Simultaneously, anode material, such as lead, is continually oxidized at the anode.

Thus, the following set of electrochemical reactions occur at the cathode and the lead anode:

Cathode: O₂+2H₂O+4e⁻→4OH⁻

Anode: 2Pb→2Pb²⁺+4e⁻

Lead oxide, though soluble in the potassium hydroxide electrolyte initially, will eventually deposit on the lead anode as the electrolyte becomes saturated with lead ions. When the cathode and the anode are electrically connected external to the sensor, an ionic current flows through the sensor. The current is proportional to the rate of oxygen consumption and can be measured by an electronic device. Connection between external sensing circuitry and the cathode is typically achieved by welding a small diameter (typically ˜0.01 inch) silver wire to the cathode. Connection between the same external sensing circuitry and the anode is accomplished by compressing (sintering) lead pellets around a small coil of nickel wire in an attempt to maximize the contact surface area between the wire and the lead particles.

As noted above, the SP76 Guidelines propose standardized properties and physical dimensions for interfaces for surface-mount fluid distribution components to be used with fluid distribution systems, such as process measurement and sample-handling systems, for example, gas sensor and analyzer systems. These guidelines only provide a starting point, through the introduction of a surface mounted interface, for developing a standardized linkage between fluid distribution components and other components of fluid distribution systems.

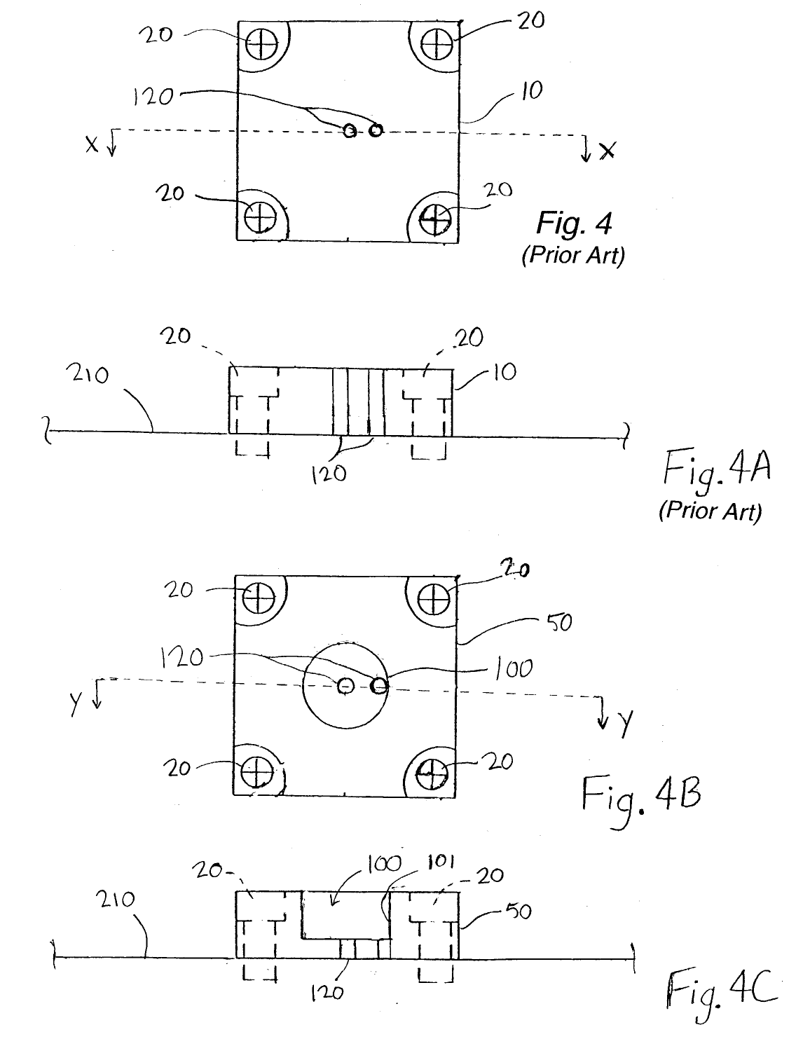

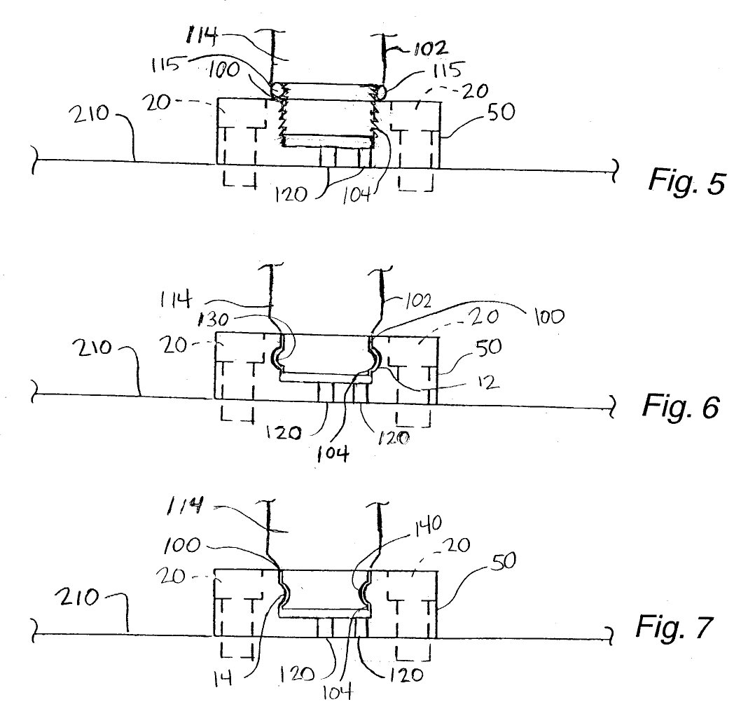

FIGS. 4 and 4A illustrate the standard, modular component design, and footprint dimensions that define interface 10 for surface-mount fluid distribution components as set forth in the SP76 Guidelines. The interface 10 is typically a solid block having openings therethrough for attachment to substrate 210 and for fluid communication with the other fluid distribution system components. The interface 10 may be formed of various resilient materials suitable for fluid distribution systems known to those of ordinary skill in the art, such as stainless steel. Interface 10 provides a near square footprint between components, such as gas sensor 110 and substrate 210 illustrated in FIGS. 5-7, and is thin relative to the length of its sides. For example, the SP76 Guidelines provide that interface 10 may be 37.0/38.2 mm square, for the standard block interface, and 56.0/57.2 mm square for the larger block interface. The height of interface 10 should range from 7 mm to 15 mm, and typically is about 11.5 mm, but can be reduced to 6.0 mm to 6.8 mm at the corners, for example, for attachment to the substrate 210. The interface 10 may include at least one each of an entering and an exiting gas pathway 120 extending therethrough for connection to and fluid communication with other fluid distribution components for fluid monitoring, measuring, and analysis. As illustrated, typically at least one pathway 120 is centrally located through the interface 10. The SP76 Guidelines provide that pathways 120 should be standardized and have a diameter of 0.5 mm for efficient and effective connection with other measuring components. As illustrated in FIGS. 4 and 4A, interface 10 is secured to substrate 210 by four threaded screws 20 located at the corners of interface 10 for secure engagement with substrate 210.

As provided by the SP76 Guidelines, interface 10 may be, generally, an adaptor bracket or linkage that acts as the interface between fluid distribution components, such as a gas sensor and substrate 210. In this form, the linkage would provide interchangeability of various gas measuring or monitoring components, such as gas sensors. Although providing a method of connecting interface 10 to substrate 210, the SP76 Guidelines do not provide guidance regarding a method of connecting fluid distribution components, such as gas sensors, to a second side of interface 10 to complete the connection with the substrate 210.

Referring now to FIGS. 4B-C and 5-7, which are for the purpose of illustrating embodiments of the invention and not for the purpose of limiting the same, FIGS. 4B-C and 5-7 depict a form of interface 10 (referred to hereinafter as interface 50) which is a modification to the interface proposed by the SP76 Guidelines (FIGS. 4 and 4A) in order to complete the connection of the interface 50 and substrate 210 with other fluid distribution components. In this regard, in order to thoroughly describe the engagement between interface 10 and the fluid distribution component, and not to limit the scope of the present invention to any particular type of fluid distribution component, the fluid distribution component set forth in FIGS. 4B-C and 5-7 will be described in the form of a gas sensor, and particularly in the form of an R-17 oxygen sensor, referred to in the figures as sensor 114, sold by Teledyne Electronic Technologies, City of Industry, Calif. As will be apparent from the following description, the coupling arrangements of the present invention provide a universal means by which gas sensors and other fluid distribution and measuring components of various manufacturers and designs may be releasably connected to systems employing interface 50.

As illustrated in FIGS. 4B-C, interface 50 includes a well or opening 100 that may, but need not, be centrally positioned around one of gas pathways 120 such that pathways 120 extend to or engage the cavity of opening 100 for fluid communication with the attached fluid distribution component. The opening 100 may be formed in interface 50 in any manner known to those of ordinary skill in the art, such as, for example, through pouring and forming techniques, or through mechanical means such as drilling or compression. Although opening 100 may be any size and shape to receive the gas sensor 114 (FIGS. 5-7), as illustrated, opening 100 preferably has a circular diameter of 16 mm. In addition, opening 100 may be formed in interface 50 with walls 101 at any depth capable of adequately securing the gas sensor 114 thereto, such as, for example, at a depth of 5 to 10 mm. Opening 100 is formed around pathways 120 such that when gas sensor 114 is attached to interface 50, flow pathways 120 are at least in general alignment with the opening in gas sensor 114 for receiving a flow or the sample fluid.

As illustrated in FIGS. 5-7, gas sensor 114 includes a housing 102 having a connecting flange 104 that includes an opening therethrough for receipt of a flow of gas to be sensed into the housing 102. Housing 102 may be a single formed component or may be separately formed components that are secured together by any known method such as, for example, heat sealing, welding, or press fit. All components that form housing 102 may be formed separately or as a single unit through processes such as, for example, pouring or injection molding. Housing 102 may be fabricated from, for example, any resilient electrically insulating material, including thermoplastic materials such as, for example, polyethylene. Housing 102 may be any geometric shape, and as incorporated into sensor 110, may be a cylindrical body. Housing 102 may have any suitable dimensions known to those skilled in the art, such as, for example, a longitudinal length of about 40 mm and a diameter of about 30 mm.

Flange 104 may be any geometric shape and size that allows gas sensor 114 to be adequately secured in opening 100, such as, for example, a cylindrical body. At least a portion of flange 104 should be sized for receipt into opening 100 of interface 50. The outer periphery of flange 104 should be sized only slightly smaller than the diameter of opening 100 in interface 50, set forth above, for secure engagement therewith. Flange 104 defines an opening therethrough for receipt of entering fluid into the housing 102 of the gas sensor 114 to be measured. The opening in flange 104 may be any geometric shape and size suitable for receiving a gaseous stream to be measured, but, as incorporated in sensor 114, includes a circular cross section and has a diameter of approximately 16 mm. As illustrated, to operably engage interface 50, flange 104 should be positioned within opening 100 to a depth sufficient to firmly secure the gas sensor 114 to the interface 50 to receive a flow of gas from pathways 120 from substrate 210 and into the opening in flange 104 via interface 50. Typically, the height of flange portion 104 is approximately 5 mm.

As illustrated in FIGS. 5-7, the outer periphery of flange portion 104 and the inner periphery of opening 100 in interface 50 may include several coupling arrangements to provide secure attachment therebetween and to allow for interchangeability of component and quick connection to and disconnection from the interface 50.

FIG. 5 illustrates one embodiment of the coupling system of the present invention, wherein flange portion 104 and opening 100 are threadedly engaged such that the gas sensor 114 is threadedly secured to interface 50. An O-ring 115 may be employed to assist in sealing gas sensor 114 to interface 50. In this embodiment, flange 104 may be completely or partially threaded so that at least a portion of flange 104 engages a mating threaded portion on the inner periphery of opening 100. In this embodiment, when flange 104 is threaded within opening 100 to effectively seal gas sensor 114 to the interface 50, the opening defined by flange 104 is at least partially aligned with pathways 120 to receive gas to be sensed.

FIG. 6 illustrates a second embodiment of the coupling system of the present invention that provides coupling of gas sensor 114 to interface 50 via snap lock engagement. As illustrated, interface 50 includes an groove 12 around at least a portion of the inner periphery of opening 100. Groove 12 is positioned to be in snap lock engagement with, and is held in place by, a mating protrusion 130 around at least a portion of the outer periphery of flange 104 of gas sensor 114. The positive locking action between the protrusion 130 and groove 12 provides the pressure required for effective sealing between the sensor 114 and the interface 50. In another embodiment of the coupling system of the present invention, illustrated in FIG. 7, the inner periphery of opening 100 may have a protrusion 14 around at least a portion of its inner periphery, and flange 104 may have a groove 140 around at least a portion of its outer periphery for snap lock engagement therebetween. In the embodiments illustrated in FIGS. 6 and 7, when at least a portion of the flange 104 is placed within opening 100 to effectively seal gas sensor 114 to the interface 50 by snap lock engagement, the opening through flange 104 is at least partially aligned with pathways 120 to receive fluid to be measured from the substrate 210.

One skilled in the art will, upon considering this description of the invention, contemplate numerous other modifications of the above coupling arrangements to provide engagement between interface 50 and the gas sensor 114. For example, the gas sensor 114 can be secured to the interface 50 via an adhesive that firmly secures the components together, but that is able to be released through removal or weakening of the adhesive bond, such as through dissolution, the application of heat, and the like, to separate the gas sensor 114 from the interface 50. Alternatively, the gas sensor 114 can be secured to the interface 50 via a clamping engagement that firmly secures the components together, and is then unclamped for interchangeability of the gas sensor 114. These variations and modifications are within the spirit and scope of the present invention, as set forth in the appended claims.

Accordingly, the coupling arrangements of the present invention may provide a universal means by which gas sensors and other distribution components of various manufacturers and designs may be interchangeable in systems employing an interface as generally set forth in SP76 Guidelines and as modified herein. Although the foregoing description has necessarily presented a limited number of embodiments of the invention, those of ordinary skill in the relevant art will appreciate that various changes in the configurations, details, materials, and arrangement of the elements that have been herein described and illustrated in order to explain the nature of the invention may be made by those skilled in the art, and all such modifications will remain within the principle and scope of the invention as expressed herein in the appended claims. In addition, although the foregoing detailed description has been directed to an embodiment of the gas sensor of the invention in the form of an oxygen sensor, it will be understood that the present invention has broader applicability and, for example, may be used in connection with the construction of all fluid distribution components. All such additional applications of the invention remain within the principle and scope of the invention as embodied in the appended claims.

We claim:

1. An interface for coupling a fluid distribution component to a substrate, the interface comprising an opening therein adapted to receive at least a portion of the distribution component, the interface including at least one entering pathway and at least one exiting pathway engaging the opening and positioned for fluid communication with the fluid distribution component and the substrate.

2. The interface of claim 1, wherein the distribution component is a gas sensor.

3. The interface of claim 1, wherein the substrate is selected from the group consisting of gas sensors, valves, flow meters, flow switches, pressure regulators, pressure reducers, pressure gauges, pressure sensors, gas analyzers, and particulate removal devices.

4. The interface of claim 1, wherein the interface includes more than one entering pathway and more than one exiting pathway.

5. The interface of claim 1, wherein at least a portion of an inner periphery of the opening is threaded so as to be capable of threadedly engaging with at least a portion of the distribution component.

6. The interface of claim 1, wherein at least a portion of an inner periphery of the opening includes a groove so as to be capable of snap lock engagement with at least a portion of the distribution component.

7. The interface of claim 1, wherein at least a portion of an inner periphery of the opening includes a protrusion so as to be capable of snap lock engagement with at least a portion of the distribution component.

8. The interface of claim 1, wherein at least one pathway is centrally positioned within the opening.

9. A coupling system, comprising:
a fluid distribution component;
a substrate; and
an interface intermediate and engaging the fluid distribution component and the substrate, the interface including an opening therein adapted to receive of at least a portion of the fluid distribution component, the interface further including at least one entering pathway and one exiting pathway engaging the opening and positioned for fluid communication with the fluid distribution component and the substrate.

10. The coupling system of claim 9, wherein the fluid distribution component is a gas sensor.

11. The coupling system of claims 9, wherein the substrate is selected from the group consisting of gas sensors, valves, flow meters, flow switches, pressure regulators, pressure reducers, pressure gauges, pressure sensors, gas analyzers, and particulate removal devices.

12. The coupling system of claim 9, wherein the fluid distribution component and the interface are connected in at least one manner selected from the group consisting of threaded engagement, snap lock engagement, clamped engagement, or adhesive engagement.

13. The coupling system of claim 12, wherein the fluid distribution component further includes a flange adapted to be at least partially received in and engage the opening.

14. The coupling system of claim 13, wherein at least a portion of an inner periphery of the opening includes a threaded portion and at least a portion of the outer periphery of the flange includes a mating threaded portion for threaded engagement therebetween.

15. The coupling system of claim 13, wherein at least a portion of an inner periphery of the opening includes a groove and at least a portion of an outer periphery of the flange includes a mating protrusion providing snap lock engagement therebetween.

16. The coupling system of claim 13, wherein at least a portion of an inner periphery of the opening includes a protrusion and at least a portion of an outer periphery of the flange includes a mating groove providing snap lock engagement therebetween.

17. The coupling system of claim 9, wherein at least one pathway is centrally positioned within the opening.

18. The coupling system of claim 9, wherein the interface includes more than one entering pathway and more than one exiting pathway.

19. A method of forming an interface for coupling to a fluid distribution component, comprising:
forming an opening in the interface positioned to receive at least a portion of the fluid distribution component, the interface including at least one entering pathway and at least one exiting pathway engaging the opening and positioned for fluid communication with the distribution component.

20. The method of claim 19, wherein the interface includes more than one entering pathway and more than one exiting pathway.

21. The method of claim 19, wherein at least a portion of an inner periphery of the opening is threaded so as to be capable of threadedly engaging with at least a portion of the distribution component.

22. The method of claim 19, wherein at least a portion of an inner periphery of the opening includes a groove so as to be capable of snap lock engagement with at least a portion of the distribution component.

23. The method of claim 19, wherein at least a portion of an inner periphery of the opening includes a protrusion so as to be capable of snap lock engagement with at least a portion of the distribution component.

24. The method of claim 19, wherein at least one pathway is centrally positioned within the opening.

25. A method of coupling a fluid distribution component to an interface, comprising:
positioning the fluid distribution component over an opening in the interface, the opening positioned to receive at least a portion of the fluid distribution component, the interface including at least one entering pathway and at least one exiting pathway engaging the opening and positioned for fluid communication with the fluid distribution component; and
securing at least a portion of the fluid distribution component in the opening to provide fluid communication between the fluid distribution component and the interface.

26. The method of claim 25, wherein the fluid distribution component is a gas sensor.

27. The method of claim 25, wherein the fluid distribution component and the interface are connected in manner selected from the group consisting of threaded engagement, snap lock engagement, clamped engagement, and adhesive engagement.

28. The method of claim 27, wherein the fluid distribution component further includes a flange for receipt into the opening and engagement therewith.

29. The method of claim 28, wherein at least a portion of an inner periphery of the opening includes a threaded portion and at least a portion of the outer periphery of the flange includes a mating threaded portion providing threaded engagement therebetween.

30. The method of claim 28, wherein at least a portion of an inner periphery of the opening includes a groove and at least a portion of an outer periphery of the flange includes a mating protrusion so as to be capable of snap lock engagement therebetween.

31. The method of claim 28, wherein at least a portion of an inner periphery of the opening includes a protrusion and at least a portion of an outer periphery of the flange includes a mating groove so as to be capable of snap lock engagement therebetween.

32. The method of claim 25, wherein at least one pathway is centrally positioned within the opening.

33. The method of claim 25, wherein the interface includes more than one entering pathway and more than one exiting pathway.
